(19) United States
(12) Patent Application Publication
(10) Pub. No.: US 2005/0137876 A1
(43) Pub. Date: Jun. 23, 2005

(54) Apparatus and method for digital watermarking using nonlinear quantization

(76) Inventors: Kiryung Lee, Seoul (KR); Dong Sik Kim, Kyungki-do (KR); Kyung Ae Moon, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/830,279

(22) Filed: Apr. 21, 2004

(30) Foreign Application Priority Data
Dec. 17, 2003 (KR) 2003-92612

(51) Int. Cl. G06K 9/00

(52) U.S. Cl. 704/273

(57) ABSTRACT

An apparatus and method for digital watermarking using nonlinear quantization are provided. The apparatus includes: an input signal processing unit which receives an original signal into which a watermark is to be embedded, performs discrete Fourier transform (DFT) of the signal, and outputs the result in predetermined number of subband units; a psychoacoustic model unit which receives the DFT coefficients and calculates a signal to mask ratio (SMR); a watermark embedder which embeds the watermark through nonlinear quantization of the DFT coefficients, which correspond to the predetermined middle frequency band, using the quantizer step size determined by the SMR; and a synthesizing unit which combines each subband except the middle frequency band and the output signal of the quantization unit, performs inverse DFT, and outputs the result. The watermarking method based on nonlinear quantization is robust against both amplitude modification and lossy compression. Using the nonlinear quantization, the embedded watermark can be extracted properly regardless of the errors in the quantizer step size, which is caused by the amplitude modification.

This application claims the priority of Korean Patent Application No. 2003-92612, filed on Dec. 17, 2003, in the Korean Intellectual Property Office, the disclosure of which is incorporated herein in its entirety by reference.

### BACKGROUND OF THE INVENTION

1. Field of the Invention

The present invention relates to an apparatus and method for embedding a watermark into a digital signal and extracting the embedded watermark, and more specifically, to a watermarking apparatus based on nonlinear quantization which imperceptibly embeds a watermark by applying psychoacoustic or psychovisual models, and also has robustness against attacks such as lossy compression and amplitude modification, and a method thereof.

2. Description of the Related Art

Since the digital signal can be easily copied without any loss of the quality, illegally copying the digital multimedia contents and distributing the illegal copy over the Internet is widespread. Against such a threat on the copyright of the digital multimedia contents, digital watermarking has been proposed as a copyright protection technology. Digital watermarking is copyright enforcement through embedding a copyright identifier into the digital signal with an imperceptible change. Digital watermarking can provides copyright enforcement after the distribution of the multimedia contents, which cannot be achieved by the conventional DRM systems.

A blind watermarking extracts an embedded watermark without using the host signal, which is the original signal without the watermark. In the blind watermarking, the host signal cause interference in extracting the embedded watermark. Blind watermarking methods based on the spread spectrum technique have been proposed. In the spread-spectrum watermarking, the host-signal interference is modeled as additive random noise and is reduced through modulation using long sequence. Currently, blind watermarking methods with the side information have been proposed. In the blind watermarking with the side information, the host-signal interference can be canceled by exploiting the side information in embedding the watermark. The blind watermarking with the side information are usually implemented with uniform scalar quantizers.

U.S. Pat. No. 6,483,927 suggests a quantization-based watermarking method, and a method of extracting the embedded watermark with the estimation of the applied attacks.

Prior art article by J. J. Eggers, R. Bauml, R. Tzschoppe and B. Girod, “Scalar Costa Scheme for Information Embedding”, IEEE Transactions on Signal Processing, vol. 51, No. 4, Apr., 2003, pp.1003-1019, suggests Scalar Costa Scheme (SCS) for embedding and extracting a watermark by using a structured codebook generated using uniform scalar quantizers. The method reduces the host-signal interference using the side information and employs a uniform scalar quantizer for practical implementation.

A watermarking system employing a uniform scalar quantizer provides practical implementation, but when the amplitude modification is applied, i.e., the size of the input signal of its watermark extractor changes, errors may occur in the process of extracting the embedded watermark. Accordingly, in order to reliably extract a watermark, the quantizer step size of the watermark extractor should be adjusted with respect to the ratio applied to the signal. In the conventional watermark extractor, a watermark extracting process is performed without adjusting the quantizer step size and in this case, the extracting performance degrades seriously with the amplitude modification. The prior art article by J. J. Eggers, R. Bauml, R. Tzschoppe and B. Girod, “Scalar Costa Scheme for Information Embedding”, IEEE Transactions on Signal Processing, vol. 51, No. 4, Apr., 2003, pp.1003-1019, suggests an algorithm for estimating the ratio by using a pilot signal, in order to reliably extract a watermark from the signal whose amplitude is changed.

In the algorithm, a pilot signal is embedded in the SCS method, and the ratio is estimated by Fourier interpretation of histograms of a pilot signal extracted from an extractor input signal. In order to estimate the ratio accurately, the length of the pilot signal should be long enough, and accordingly, when the length of the entire signal is short, it is difficult to estimate the ratio.

In addition, when the embedding strength of the watermark is adjusted in detail by using psychoacoustic or psychovisual models, the quantizer step size is determined for each signal interval. In this case, as the embedding process becomes more detail, the interval, where the quantizer step size is determined, becomes shorter. Since the accurate estimation of the ratio requires long signal length, the estimation-based method has limited applications.

### SUMMARY OF THE INVENTION

The present invention provides a watermarking method based on nonlinear quantization, which enables imperceptible embedding using psychoacoustic or psychovisual models, and also has robustness against attacks such as lossy compression and amplitude modification, and an apparatus thereof.

According to an aspect of the present invention, there is provided an apparatus for embedding a watermark based on nonlinear quantization comprising: an input signal processing unit which receives an original signal, into which a watermark is to be embedded, performs discrete Fourier transform (DFT) of the signal, and outputs the result in a predetermined number of subband units; a psychoacoustic model unit which receives the DFT coefficients and calculates a signal to mask ratio (SMR); a watermark embedder which embeds the watermark through nonlinear quantization of the DFT coefficients, which correspond to the predetermined middle frequency band, using the quantizer step size determined by the SMR; and a synthesizing unit which combines each subband except the middle frequency band and the output signal of the quantization unit, performs inverse DFT, and outputs the result.

According to another aspect of the present invention, there is provided an apparatus for extracting a watermark in a blind method from a signal with an embedded watermark, comprising: an input unit which performs DFT of the signal and divides into a predetermined number of subband units; a psychoacoustic model unit which receives the DFT coefficients, applies a psychoacoustic model, and estimates the quantizer step size which is used when the watermark is embedded; and a watermark extractor which extracts the watermark through nonlinear quantization of the DFT coefficients, which correspond to the predetermined middle frequency band, using the estimated quantizer step size.

According to still another aspect of the present invention, there is provided a method for embedding a watermark based on nonlinear quantization comprising: performing DFT of an original signal and dividing into a predetermined number of subband units; by applying a psychoacoustic model to the DFT coefficients, calculating a signal to mask ratio (SMR); embedding the watermark through nonlinear quantization of the DFT coefficients, which correspond to the predetermined middle frequency band, using the quantizer step size determined by the SMR; and combining each subband except the middle frequency band and the output signal of the nonlinear quantization, performing inverse DFT and outputting the result.

According to yet still another aspect of the present invention, there is provided a method for extracting a watermark in a blind method from a signal with an embedded watermark, comprising: performing DFT of the signal and dividing into a predetermined number of subband units; by applying a psychoacoustic model to the original signal divided into the subbands, estimating the quantizer step size which is used when the watermark is embedded; and extracting the watermark through nonlinear quantization of the DFT coefficients, which correspond to the predetermined middle frequency band, using the estimated quantizer step size.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for embedding a watermark according to the present invention;

FIG. 2 is a block diagram of an apparatus for extracting a watermark according to the present invention;

FIG. 3 is a detailed block diagram of a watermark embedder of FIG. 1;

FIG. 4 is a detailed block diagram of a watermark extractor of FIG. 2;

FIG. 5 is a flowchart of the steps performed by a method for embedding a watermark according to the present invention;

FIG. 6 is a flowchart of the steps performed by a method for extracting a watermark according to the present invention; and

FIGS. 7a through 7c are diagrams showing results of simulations performed by applying the apparatus and method for embedding a watermark according to the present invention.

### DESCRIPTION OF THE PREFERRED EMBODIMENTS

The present invention will now be described more fully with reference to the accompanying drawings, in which exemplary embodiments of the invention are shown. For convenience of explanation, an apparatus and a method of the present invention will be explained at the same time. Before detailed description, a brief of the present invention will now be explained.

In the present invention, a watermarking method based on nonlinear quantization using A-law companding will be disclosed. Since the method disclosed by the present invention has a property that it is robust against an error in the quantizer step size at the extractor, it is robust against the amplitude modification attack that may be applied to a watermark-embedded signal. In addition, since it does not need to separately transmit information on the quantizer step size, the method enables imperceptible embedding of a watermark using detailed psychoacoustic or psychovisual models.

For robustness against lossy compression and signal processing, a watermark is embedded into transform coefficients corresponding to the middle frequency. For security of embedded watermark information, a watermark is embedded into coefficients to which random permutation and Hadamard transform are sequentially applied. Also, embedding strength of a watermark is determined through psychoacoustic or psychovisual models so that users cannot recognize the embedded watermark.

By using psychoacoustic or psychovisual models, the embedding strength of a watermark for each interval of a signal is determined and the quantizer step size according to the embedding strength is determined. Instead of transmitting the quantizer step size for each interval as side information, a method by which the quantizer step size corresponding to each interval is estimated from an input signal by an extraction apparatus and used is employed.

Accordingly, since a method robust against errors in the quantizer step size of a nonlinear quantizer is used in the present invention, watermark information can be correctly extracted even when an error occurs in the quantizer step size estimated in a watermark extraction apparatus.

The following explanation will focus on watermarking of a digital audio signal, but the present invention will be applied to a still image signal or a video signal in the same manner by replacing a psychoacoustic model with a psychovisual model.

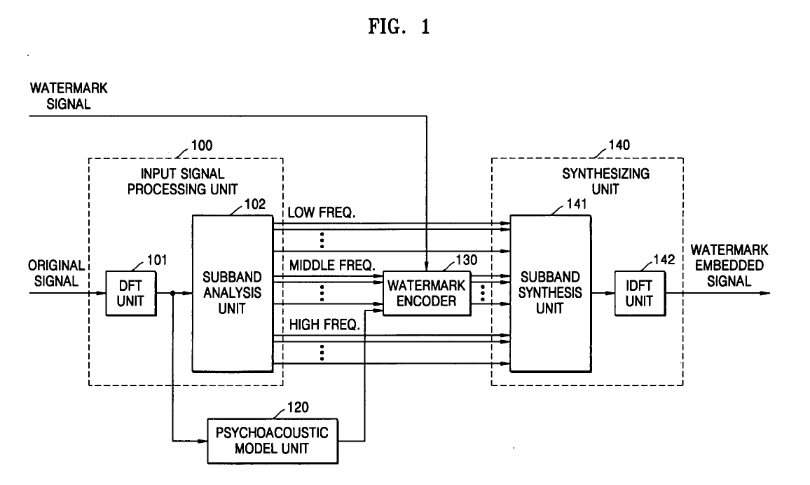

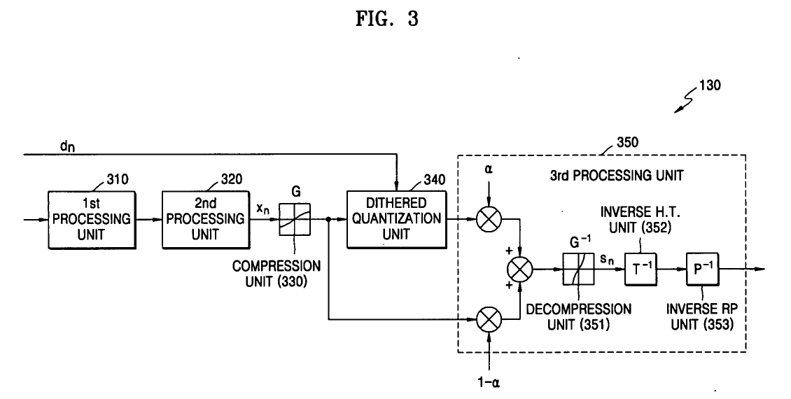

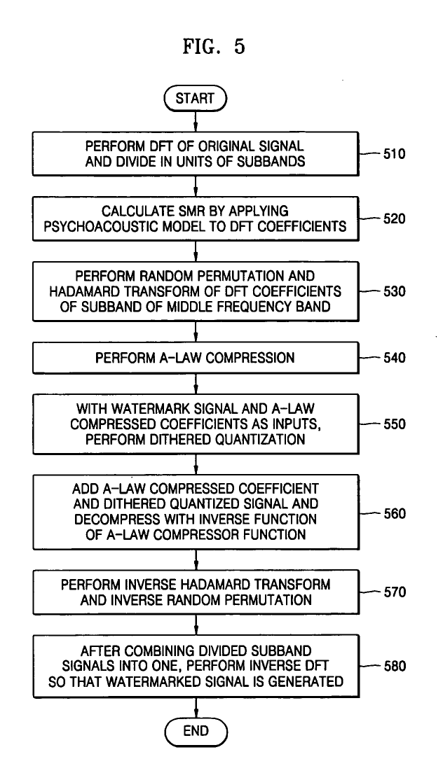

FIG. 1 is a block diagram of an apparatus for embedding a watermark according to the present invention, and FIG. 3 is a detailed block diagram of a watermark embedder 130 of FIG. 1. FIG. 5 is a flowchart of the steps performed by a method for embedding a watermark according to the present invention.

An input signal processing unit 100 is broken down to a DFT unit 101 and a subband analysis unit 102, and the DFT unit 101 performs discrete Fourier transform (DTF) of an input audio signal being input, and outputs the result to the subband analysis unit 102 and a psychoacoustic model unit 120. The subband analysis unit 102 divides the input DFT coefficients into 32 subbands and outputs. Among the subbands, considering robustness against lossy compression and so on, subbands corresponding to the middle frequency are selected, as a domain into which a watermark is embedded. It is preferable that 16 subbands from the 4th through the 19th subband among the entire 32 subbands are selected as the middle frequency band for embedding a watermark in step 510.

Meanwhile, the psychoacoustic model unit 120 receives the DFT coefficients, calculates a signal to mask ratio (SMR) through a psychoacoustic model, and outputs the result in step 520. The calculated SMR and DFT coefficients of the middle frequency band are input to a watermark embedder 130.

Detailed element blocks of the watermark embedder 130 will be explained referring to FIG. 3. For each selected subband, the SMR value is used as a document to watermark ratio (DWR) value, and for security of an embedded watermark, a first processing unit 310 performs random permutation of DFT coefficients and outputs the result, and a second processing unit 320 sequentially performs Hadamard transform of the randomly permutated DFT coefficients, and outputs the result in step 530. Here, DWR denotes the embedding strength of watermark, and as the DWR value decreases, the embedding strength of watermark increases. Then, embedding a watermark is performed and the process for embedding a watermark in each subband will now be explained in detail.

Embedding a watermark in the watermark embedding apparatus is implemented through a dithered scalar quantizer 340 and a compression unit 330 which applies A-law compressor function G that makes quantization nonlinear. For input x, which is a constant, A-law compressor function G is defined as the following equations 1a and 1b:
G(x):=x,|x|<A (1a)

$$G ( x ) := A ( 1 + K ln \frac{\vert x \vert}{A} ) sgn ( x ) , \vert x \vert \geq A \qquad ( 1 b )$$

Here, sgn(x) denotes signum function, K denotes a real number that can be adjusted when a watermark embedding apparatus is operated, and A denotes A-law quantization coefficient in step 540. As in the equations 1a and 1b, the input range of G is divided into two regions according to the absolute value |x|; the logarithmic region, where |x|≧A, and the linear region, where |x|<A. The logarithmic companding is applied only to the logarithmic region. A watermark is embedded so that the quantization index of the DC component in the Hadamard transform may have an even number.

After the compression unit 330, the dithered quantization unit 340 receives the DFT coefficients of the middle frequency band compressed by G, and the watermark signal, applies the following equation 2 and outputs the result:

$${Q}_{Δ , d} ( x ) := Δ ( ⌊ \frac{x}{Δ} - \frac{d}{2} + \frac{1}{2} ⌋ + \frac{d}{2} ) \qquad ( 2 )$$

Here, └c┘ denotes an integer that is less than or equal to an arbitrary real number c. Constant Δ that is a positive number denotes the quantizer step size, and d denotes a dither signal having a binary value in step 550.

A third processing unit 350 comprises a decompression unit 351, an inverse HT unit 352, and an inverse RP unit 353. The DFT coefficients of the middle frequency band passing through the compression unit 330 and the signal passing through the dithered quantization unit 340 are averaged with respective weights. The decompression unit 351 decompresses the averaged signal, by applying G⁻¹ that is the inverse of compressor function G of the compression unit 330 in step 560. Also, the inverse HT unit 352 performs inverse Hadamard transform and outputs the result, and the inverse RP unit 353 performs the inverse of the random permutation at the first processing unit 310 and outputs the result in step 570.

More specifically, the processing process of the third processing unit 350 will be explained. Let the sequence (xₙ) denote the output of the second processing unit 320. Let a binary sequence of dₙε{0,1 } (dₙ of FIG. 3) denote a watermark signal, and the sequence (sₙ) denote the watermarked signal. The watermarked signal is then obtained by the following equation 3:
sₙ=G⁻¹((1−α)G(xₙ)+αQ₆₆_{_{edn}}G(xₙ)) (3 )

Here, α(0<α<1 ) and Δₑ are embedding parameters used in the watermark embedding process and are determined differently for each subband. The embedding parameters are determined based on an estimate of a noise strength obtained from lossy compression parameter and the SMR obtained from a psychoacoustic model.

Then, a synthesizing unit 140 synthesizes the signal of the middle frequency band with an embedded watermark, and the signal of the remaining band. More specifically, among the signals divided into respective subbands by the subband analysis unit 102, a subband synthesis unit 141 synthesizes the signals of the low frequency band and high frequency band, and the signal of the middle frequency band into which a watermark is embedded by the watermark embedder 130.

Finally, an IDFT unit 142 performs inverse DFT of the coefficients of respective subbands combined into one signal by the subband synthesis unit 141, and outputs the result such that a signal into which a watermark is embedded is generated in step 580.

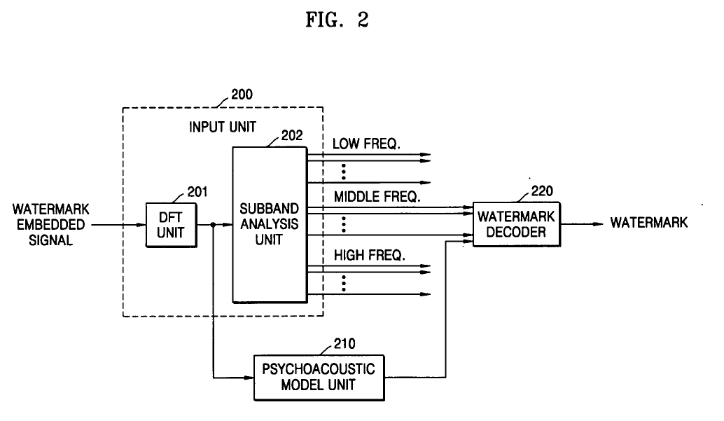

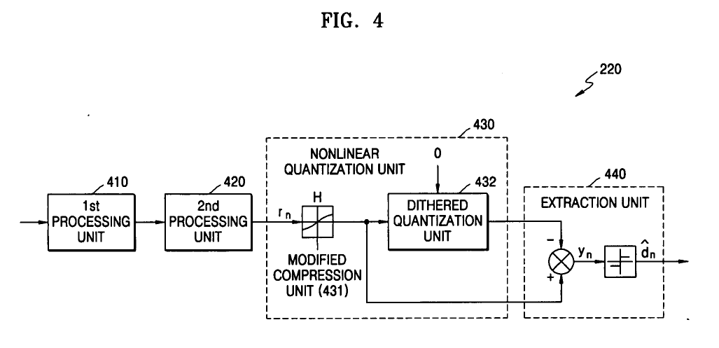

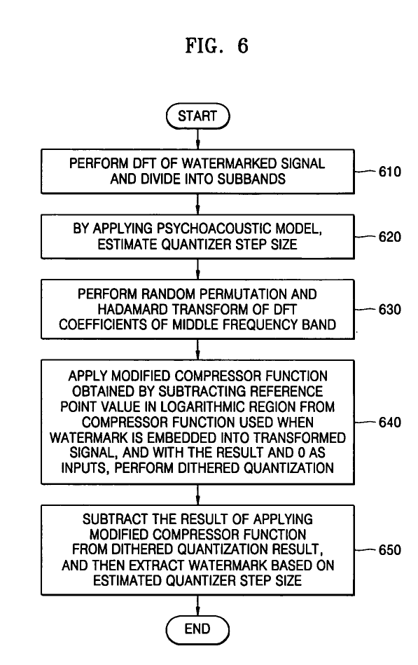

Referring to FIGS. 2, 4 and 6, an apparatus and method for extracting a watermark will now be explained. FIG. 2 is a block diagram of an apparatus for extracting a watermark according to the present invention, FIG. 4 is a detailed block diagram of a watermark extractor of FIG. 2, and FIG. 6 is a flowchart of the steps performed by a method for extracting a watermark according to the present invention.

Referring to FIG. 2 showing basic blocks of the watermark extracting apparatus, an input unit 200 receives a signal with an embedded watermark, performs DFT of the signal, divides into subbands and then outputs the result in step 610. A DFT unit 201 and a subband analysis unit 202 perform the same functions as those of the corresponding blocks in the watermark embedding apparatus and therefore the explanation will be omitted.

Simultaneously with an input signal being divided into subbands, a psychoacoustic model unit 210 estimates the size Δ_{d} of a quantizer used in detecting a watermark by using a psychoacoustic model in step 620. The estimated quantizer step size may have an error different from the value used in the watermark embedding apparatus, due to the effect of the embedded watermark signal, lossy compression, and so on. An extraction method according to the present invention can provide a correct detection result because it is robust against this error. As in the watermark embedding apparatus and method, DFT coefficients are divided into 32 subbands and selected subband signals, that is, signals of the middle frequency band, are input to a watermark extractor 220. A first processing unit 410 performs random permutation of the input signals of the middle frequency band, and outputs the result, and a second processing unit 420 performs again Hadamard transform and outputs the result in step 630.

A process for extracting a watermark in each subband will now be explained. A nonlinear quantization unit 430 applies a modification of the compressor function used in the watermark embedding apparatus, to the DFT coefficients passing through the first and second processing units 410 and 420, and performs dithered quantization. More specifically, it is assumed that rₙ of FIG. 4 indicates a watermark extractor input signal for each subband. At this time, the DC coefficient of the Hadamard transform is used as a reference point in order to reduce an error due to the difference between the size Δₑ of a quantizer in the watermark embedding apparatus and the size Δ_{d} of a quantizer in the watermark extracting apparatus. In a modified compression unit 431, the compressor function G used in the watermark embedding apparatus is modified in the form of subtracting a reference point value in a logarithmic region and then is used. Thus modified compressor function H is defined as the following equations 4a and 4b:
H(x):=G(x),|x|<A (4a)
H(x):=G(x)−G(rₘ)sgn(rₘx),|x |≧A (4b)

Here, rₘ denotes the value of signal rₙ corresponding to reference point m.

A dithered quantization unit 432 receives the output of applying the modified compressor function H(x) and 0, performs dithered quantization as described above, and outputs the result in step 640.

An extraction unit 440 receives the output of the dithered quantization unit 432 and the output of the modified compression unit 420 and obtains the difference yₙ, which in turn indicates a quantization error by nonlinear quantization using the modified compressor function H(x) and is defined as the following equation 5:
yₙ:=H(rₙ)−Q_{Δdi d},0(H(rₙ)) (5)

An estimated watermark signal \hat{d}ₙ, which is the output of the extraction unit 440, is obtained from yₙ, and can be obtained by two schemes including hard decision decoding and soft decision decoding. The hard decision and soft decision decoding are performed by the following equations 6a through 7:

$$\begin{matrix}{\hat{d}}_{n} = 0 , \vert {y}_{n} \vert < \frac{{Δ}_{d}}{4} & ( 6 a ) \\ {\hat{d}}_{n} = 1 , \vert {y}_{n} \vert \geq \frac{{Δ}_{d}}{4} & ( 6 b ) \\ {\hat{d}}_{n} = {y}_{n} - \frac{{Δ}_{d}}{4} & ( 7 )\end{matrix}$$

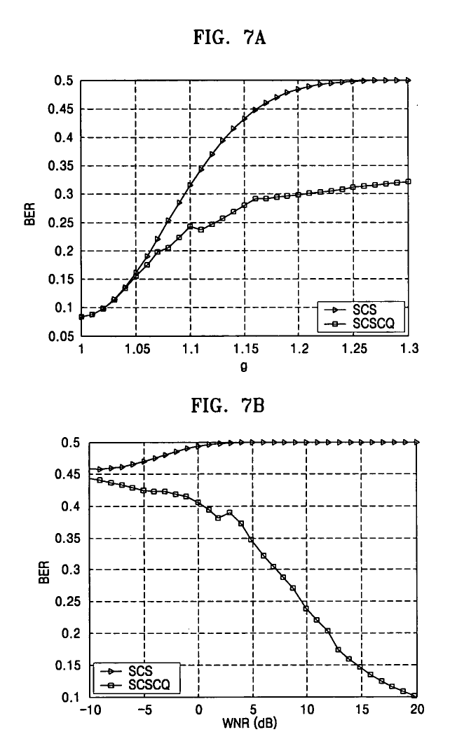

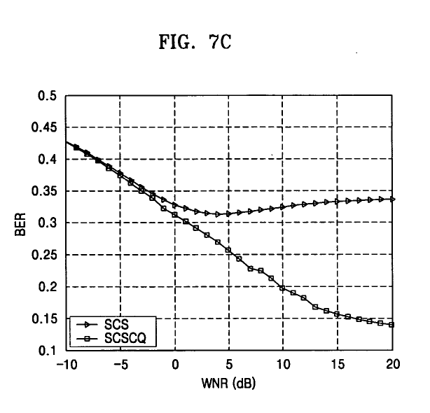

In order to improve the extraction reliability, the soft decision decoding can be used. When modulation with a pseudo random sequence and the soft decision decoding are used, watermark information is obtained by calculation of correlation between extracted code \hat{d}ₙ and codes in a codebook. The index of a code showing the largest correlation corresponds to the embedded watermark information. However, the present invention can be used with any modulation scheme with a pseudo random or an error correcting codes. In order to investigate the performance of the present invention regardless of specified modulating sequence, simulations with hard decision decoding scheme, which corresponds to the present invention without modulation scheme, are performed and the results are shown in FIGS. 7a through 7c. In FIGS. 7a and 7b, the abscissa denotes the scale factor g of the amplitude modification, which applied to a watermarked signal, and the ordinate denotes the bit error rate (BER). Also, SCS indicates the result when the prior art method is applied, and SCSCQ indicates the result when the present invention is applied. In FIG. 7c, watermark to noise ratio (WNR) denotes a number indicating the strength of a noise added after a watermark is embedded, and a decrease in WNR means an increase in the strength of noise. As shown in FIGS. 7a through 7c, the watermarking method based on nonlinear quantization according to the present invention has a lower BER than that of the prior art quantization-based watermarking method.

The watermark embedding or extracting method based on nonlinear quantization according to the present invention can also be embodied as computer readable codes on a computer readable recording medium. The computer readable recording medium is any data storage device that can store data, which can be thereafter read by a computer system. Examples of the computer readable recording medium include read-only memory (ROM), random-access memory (RAM), CD-ROMs, magnetic tapes, floppy disks, flash memory, optical data storage devices, and carrier waves (such as data transmission through the Internet). The computer readable recording medium can also be distributed over network coupled computer systems so that the computer readable code is stored and executed in a distributed fashion. Also, the font ROM data structure according to the present invention can be implemented as computer readable codes on a recording medium such as ROM, RAM, CD-ROMs, magnetic tapes, floppy disks, flash memory, and optical data storage devices.

While the present invention has been specifically shown and described with reference to exemplary embodiments thereof, it will be understood by those of ordinary skill in the art that various changes in form and details may be made therein without departing from the spirit and scope of the present invention as defined by the following claims.

As described above, the watermarking apparatus and method based on nonlinear quantization uses A-law companding so that even when an error occurs in the quantizer step size, robust watermark extraction can be performed. Accordingly, with the present invention, a correct detection result can be provided even when the amplitude of a watermark embedded signal changes. In addition, in the present invention, instead of transmitting the quantizer step size, an identical psychoacoustic model is used for a watermark extractor to estimate the quantizer step size and therefore it is possible to precisely adjust the embedding strength of watermark in each interval of a signal. The watermarking method based on nonlinear quantization is robust against errors of a quantizer step size and accordingly, even when error occurs in the quantizer step size estimated by a watermark extractor due to the effect of an embedded watermark signal or lossy compression, watermark information can be extracted properly.

1. An apparatus for embedding a watermark based on nonlinear quantization comprising:
an input signal processing unit which receives an original signal into which a watermark is to be embedded, performs discrete Fourier transform (DFT) of the signal, and outputs the result in a predetermined number of subband units;
a psychoacoustic model unit which receives the DFT coefficients and calculates a signal to mask ratio (SMR);
a watermark embedder which embeds the watermark through nonlinear quantization of the DFT coefficients, which correspond to the predetermined middle frequency band, using the quantizer step size determined by the SMR; and
a synthesizing unit which combines each subband except the middle frequency band and the output signal of the quantization unit, performs inverse DFT, and outputs the result.

2. The apparatus of claim 1, wherein the watermark embedder comprises:
a first processing unit which receives the DFT coefficients of the middle frequency band, performs random permutation, and outputs the result;
a second processing unit which performs Hadamard transform of the output of the first processing unit and outputs the result;
a compression unit which performs A-law compression of the transformed DFT coefficients output from the second processing unit;
a dithered quantization unit which receives the A-law compressed DFT coefficients and the watermark, performs dithered quantization, and outputs the result; and
a third processing unit which applies a predetermined weight to the output signal of the dithered quantization unit, performs the A-law decompressing, then performs inverse Hadamard transform and inverse random permutation, and outputs a signal with an embedded watermark.

3. The apparatus of claim 2, wherein a quantizer step size for the dithered quantization unit and the weight are determined based on an estimate of a noise strength obtained from lossy compression parameter and the SMR obtained from a psychoacoustic model, and has a different value in each subband in the middle frequency band.

4. An apparatus for extracting a watermark in a blind method from a signal with an embedded watermark, comprising:
an input unit which performs DFT of the signal and divides into a predetermined number of subband units;
a psychoacoustic model unit which receives the DFT coefficients, applies a psychoacoustic model, and estimates the quantizer step size which is used when the watermark is embedded; and
a watermark extractor which extracts the watermark based on the DFT coefficients for a predetermined middle frequency band among the subbands and the estimated quantizer step size.

5. The apparatus of claim 4, wherein the watermark extractor comprises:
a first processing unit which receives the DFT coefficients of the middle frequency band, performs random permutation and outputs the result;
a second processing unit which performs Hadamard transform of the output of the first processing unit and outputs the result;
a nonlinear quantization unit which receives the Hadamard transformed signal, performs predetermined modified compression, and with the nonlinear quantization result and the estimated quantizer step size as inputs, performs dithered quantization; and
an extraction unit which extracts the watermark based on the difference between the output of the nonlinear quantization unit and the dithered quantization result.

6. The apparatus of claim 5, wherein the nonlinear quantization unit subtracts a value in a logarithmic region with the DC coefficient of the Hadamard transform as a reference point, from the compressor function applied when the watermark is embedded.

7. A method for embedding a watermark based on nonlinear quantization comprising:
performing DFT of an original signal into which a watermark is to be embedded and dividing into a predetermined number of subband units;
by applying a psychoacoustic model to the DFT coefficients, calculating a signal to mask ratio (SMR);
performing nonlinear quantization based on the DFT coefficients for a predetermined middle frequency band among the subbands, the watermark, and the SMR; and
combining each subband except the middle frequency band and the output signal of the nonlinear quantization, performing inverse DFT and outputting the result.

8. The method of claim 7, wherein the nonlinear quantization comprises:
performing random permutation of the DFT coefficients of the middle frequency band, and then performing Hadamard transform;
generating a first signal by performing A-law compressing of the transformed DFT coefficients;
generating a second signal with an embedded watermark, by performing dithered quantization with the A-law compressed DFT coefficients and the watermark signal as inputs;
generating a third signal by applying a predetermined weight to each of the first signal and the second signal, and then adding the signals; and
performing A-law decompressing of the third signal and then, performing inverse Hadamard transform.

9. The method of claim 8, wherein in generating a third signal, the quantizer step size for the dithered quantizing unit and the weight are determined based on an estimate of a noise strength obtained from lossy compression parameter and the SMR obtained from a psychoacoustic model, and has a different value in each subband in the middle frequency band.

10. The method of claim 7, wherein the original signal into which the watermark is to be embedded is an audio signal.

11. The method of claim 7, wherein if the original signal into which the watermark is to be embedded is an image signal or a video signal, then a psychovisual model is used for imperceptible embedding, instead of a psychoacoustic model.

12. A method for extracting a watermark in a blind method from a signal with an embedded watermark, comprising:
performing DFT of the signal and dividing into a predetermined number of subband units;
by applying a psychoacoustic model to the original signal divided into the subbands, estimating the quantizer step size which is used when the watermark is embedded; and
extracting the watermark based on the DFT coefficients for a predetermined middle frequency band among the subbands and the estimated quantizer step size.

13. The method of claim 12, wherein the extracting the watermark comprises:
performing random permutation of the DFT coefficients of the middle frequency band among the subbands, and then performing Hadamard transform;
performing predetermined modified compression of the Hadamard transformed signal and then, performing dithered quantization; and
extracting the watermark based on the modified compression result, the dithered quantization result, and the estimated quantizer step size.

14. The method of claim 13, wherein in the performing predetermined modified compression and dithered quantization, the modified compression comprises:
subtracting a value in a logarithmic region with the DC coefficient of the Hadamard transform as a reference point, from the compressor function applied when the watermark is embedded.

15. The method of claim 12, wherein the signal with the embedded watermark is an audio signal.

16. The method of claim 12, wherein if the signal with the embedded watermark is an image signal or a video signal, then a psychovisual model is used for imperceptible embedding, instead of a psychoacoustic model.

17. A computer readable recording medium having embodied thereon a program for any one method of claim 7 and claim 12.
